(19) United States
(12) Patent Application Publication
(10) Pub. No.: US 2021/0362476 A1
(43) Pub. Date: Nov. 25, 2021

(54) GLAZING WITH OPTICALLY TRANSPARENT SENSOR AREA

(71) Applicant: AGC GLASS EUROPE, Louvain-la-Neuve (BE)

(72) Inventors: Meijie LI, Louvain-la-Neuve (BE); Yannick SARTENAER, Vedrin (BE); Quentin FRASELLE, Mont Saint Guibert (BE)

(73) Assignee: AGC GLASS EUROPE, Louvain-la-Neuve (BE)

(21) Appl. No.: 17/252,568

(22) PCT Filed: Jul. 3, 2019
(86) PCT No.: PCT/EP2019/067900

§ 371 Date: Dec. 15, 2020

(30) Foreign Application Priority Data
Jul. 6, 2018 (EP) 18182293.3

(51) Int. Cl. B32B 17/10; B32B 3/08; G01S 7/481; B60J 1/00

(52) U.S. Cl. CPC B32B 17/10293; B32B 17/10036; B32B 3/08; G01S 7/4811; B60J 1/001; G01S 17/931; B32B 2307/412; B32B 2315/08; B32B 2457/00; B32B 2605/006; B32B 2605/08; B32B 2255/00

(57) ABSTRACT

A pane substrate with an optically transparent area comprising at least one optical device on the surface of the pane integrated in the optically transparent area. At least one coated glass patch is provided locally between the pane and the optical device.

The present invention relates to a pane substrate, and more particularly a glass pane, with an optically transparent sensor area, a method for production thereof, and use thereof.

Many motor vehicles, airplanes, helicopters, and ships are equipped with various optical sensors. Examples of optical sensors are camera systems, such as video cameras, night vision cameras, residual light amplifiers, passive infrared detectors such as FUR (forward looking infrared) or infrared-based remote sensing device, such as LiDAR sensing device. The camera systems can use light in the ultraviolet (UV), visible (VIS), and infrared wavelength range (IR).

In motor vehicles, these camera systems or infrared-based remote sensing device, such as LiDAR sensing device can be placed behind the windshield inside the passenger compartment. Thus, they offer the capability of detecting hazardous situations and obstacles in a timely manner even in road traffic.

Other areas that use optical sensors include electronic distance measurement (EDM), for example, using laser distance meters. The distance to other motor vehicles can be determined. Such systems are common in the military field of application, but there are also many possibilities for civilian use. By measurements of the distance to the preceding vehicle, it is possible to determine the necessary safety distance and to significantly increase traffic safety. With automatic warning systems, the danger of a rear-end collision is significantly reduced.

In these glass applications, glass is most of the time coated in order to fulfill its basic functional requirements, and/or to offer additional functions to provide a functionalized glass. Depending on their offered functions, coatings may include antireflective (AR) coatings, high reflective coatings, bandpass filter coatings, tinted coatings, low E coatings, absorptive coatings (to absorb UV, acoustic waves . . . ), heated coatings, hydrophobic coatings, etc.

When these camera systems or infrared-based remote sensing device, such as LiDAR sensing device are used behind a glass pane and more particularly behind a windshield or a glass trim element, it is preferable to have an anti-reflective coating in combination or not with another functionalized coating such as tinted coating and heated coating in the optical sensor area. Indeed, sometimes a locally applyed coating is needed in the area wherein the optical sensor is provided to ensure the best sensor performance. Thus, a particular coating or a different coating is required in a small area of the glazing in comparison with the full surface of the glazing. In this case, dedicated coatings are preferred and/or only allowed to be localized in these small areas, rather than to cover the full piece of the glass pane substrate.

However, in term of process, it is generally difficult without over cost or without complexing the manufacturing process to apply a needed coating in a limited or small area from a bigger substrate. Thus, there is a need of a simplified process to apply a particular coating in small area from a bigger substrate.

For example, when infrared (IR) sensors (e.g. LiDAR sensors) is integrated behind automotive glazing (e.g. windshields, sidelites, backlites and glass trims like B-pillars)for autonomous driving, The automotive glazing is usually designed to block IR light, in order to provide thermal comfort. However IR sensors, work with IR light. For an integrated LiDAR sensor, it has to send out IR laser light through automotive glazing to the detection target, and then the reflected IR laser light by the target has to go through automotive glazing to be collected by the LiDAR sensor. This means that the area where the IR sensor is integrated, is required to have sufficient transmission for IR light. Then AR coating for IR light is needed and has to be localized only on the integration area ie optically transparent area.

There are also other examples for automotive glazing with a need of localized coatings. In additional to IR sensors, many different kinds of Advanced Driver Assistance Systems (ADAS) sensors may be integrated on automotive glazing. To integrate a camera, a localized heated coating is beneficial because the provided defrost function can ensure a clearer view for the sensor. To integrate a radar sensor, a localized coating may be needed to pass acoustic waves, while other parts of the automotive glazing absorb acoustic waves to avoid noises inside the car.

The examples above of localized coatings on automotive glazing also apply on other means of transport, such as train, plane . . . but also other vehicles like drones.

Furthermore, to integrate LiDAR sensors on a big piece of glass pane, such as windshield (sidelites, backlites and sunroofs) is not only useful for autonomous driving, but also applicable for displays, touch screens, architectural glazing (e.g. windows, facades, roofs and greenhouses . . . ), solar-energy applications (photovoltaic and solar thermal panels), electronics industry (displays and touch screens), and so on. etc. to provide additional functions like three dimensional (3D) recognition, and face ID. In any case, a localized AR coating for IR light is preferred.

There are also many other cases where localized coating on a big piece of glass is useful. For glass roofs, sensors (like rain sensors, light sensors...) might be integrated, and the integration area might need a localized coating to ensure the sensor performance. For windows, special functions (e.g. touch sensors) might be added, where a localized coating on the small area is needed to fulfill the special requirements by the special functions.

In glass industry, there are different coating techniques available, including Physical Vapor Deposition (PVD) methods (such as. sputtering deposition, thermal vapor deposition), Chemical deposition methods (such as chemical reduction, pyrolytic coating like Chemical Vapor Deposition (CVD), sol-gel deposition), and Plasma-Assisted Chemical Vapor Deposition (PACVD).

However these methods are designed to coat the major surface of the piece of glass or more generally a piece of substrate. However, it is very difficult or even impossible to coat a small area of the substrate over a big surface of the substrate and more particularly a glass substrate.

Indeed, for online coating techniques like CVD, the glass is coated during its manufacturing process. In this process, a gaseous chemical mixture is brought to the surface of the hot glass substrate, and a pyrolytic reaction occurs to deposit a coating which bonds to the glass. As this happens in the furnace, it is only possible to coat the full piece of glass. Also the bonding is very strong and difficult to remove afterwards, so it is not possible to have a small coated area while removing the coating from other parts. Therefore, it is not possible to achieve localized coatings.

For offline coating techniques like PVD, chemical reduction, sol-gel deposition and PACVD, the glass is coated after its manufacturing process, by sputtering, spraying, spinning, or dipping into the coating materials. Although the available techniques are designed to coat the full piece of glass, there are different methods to have localized coatings. However every method has its own drawbacks.

The straightforward method is to coat all the surface of the glass substrate, and then to remove the coating from the undesired parts (e.g. by laser de-coating), so that the required coating is left only on the small area. The drawbacks are:
the coating process normally requires a vacuum chamber and/or other equipments big enough to hold the full piece of substrate. This dramatically increases the cost and reduces the feasibility;
the removed coating materials from a fully coated surface of the substrate to provide a required coating in the requested area are a waste, which is also a source of cost;
the de-coating process is an additional process, which increases the cost and complexity. Also the this process is not always possible, and sometimes the de-coating quality is not ensured;
it is not useful for techniques only working with small-sized glass. For example, Radical Assisted Sputtering (RAS) coats glass sized max. 20 cm by 30 cm.
   The second method is to use masks during the coating process. A mask can block the coating materials from reaching the glass substrate, so that the coating is only dedicated at a small area. The drawbacks are as follows: The required coating facility, like the vacuum chamber, has to be big enough to hold the full piece of glass, which increases the cost and the feasibility; The blocked coating materials are a waste, which is also a source of cost; the mask is an additional element, which is expensive; the alignment between the mask and the glass substrate is an additional step, which induces the cost and the complexity; it is not useful for techniques only working with small-sized glass.

The third method is for coating methods using vacuum chambers. A small vacuum chamber covers only the small area where dedicated coatings are required. It reduces the size of the vacuum chamber, and avoids the waste of the coating material, the de-coating process and the coating masks. However the design of such chamber can be tricky. The edges of the chamber have to be in contact with the glass substrate, but not to change the surface quality of the contact area. Also for bended glass substrates (like WS), the design of the vacuum chamber is difficult and has to be changed depending on the shapes of the glass substrates and the location of the small coated area.

It is known for prior art, a plastic patch provided with coatings can be attached to glass substrate to offer localized coating functions. However, coatings on plastic patches have the following drawbacks:
the bonding between the coating materials and the plastic substrate is usually more difficult.;
the plastic patch is less resist to critical conditions during the coating process, e.g. high temperature, chemical corrosion . . . . It limits the coating possibilities;
the lifetime of the plastic patch is much shorter;
the plastic is less resistant to environmental conditions, both mechanically and chemically.

Thus, an object of the present invention is to provide a functionalized glass patch with dedicated coatings to be attached to a relatively bigger substrate provided or not with a coating (different from the coating provided on the functionalized glass patch). More particularly, an object of the present invention is to provide a pane substrate and more particularly a glass substrate with an optically transparent sensor area placed behind the pane substrate, that can be produced easily from finished, standardized panes without major modifications. Thus, the present invention concerns a pane substrate with at least an optically transparent area comprising at least one optical device on the surface of the pane integrated in the optically transparent area.

According to the present invention, at least one coated glass patch is provided locally between the pane and the optical device.

In a particular embodiment of the present invention, the present invention concerns a functionalized glass patch with dedicated coatings provided in the optically transparent sensor area placed between the windshield and the optical sensor.

Thus the present invention may be used for a glass substrate, but the substrate could be other materials as well as plastic substrate, plexiglass substrate . . .

According to the present invention, the pane substrate may be fully coated or not or partially coated. The nature of the coating on the major surface of the pane substrate and the function of the sensor will determine the removal of the coating in the optically transparent area if a coating is provided on the surface of the pane substrate.

According to the present invention, optical device may be a light source such as a laser, a diode, a sensor such as LIDAR, a camera . . .

In a preferred embodiment of the present invention, the optical device is an optical sensor.

According to the present invention, the functionalized glass patch may have one-side or double-side coatings, to provide one or multiple different functions compared with the major substrate of the pane substrate on which the glass patch is provided.

The functionalized glass patch according to the present invention is fixed to the pane substrate and more particularly to a glass substrate. The functionalized glass patch may be fixed during the autoclaving of the assembly comprising the substrate and the functionalized glass patch. The autoclaving is a well know technique commonly used for automotive glazing. An interlayer (like PVB, EVA and others) can be used between the functionalized glass patch and the glass substrate. In case of laminated glass substrates (like windshield), the functionalized glass patches can be attached in the meantime when the glass substrates are autoclaved. The other method is to use optical bonding materials (like 3M materials, AGC Infoverre) to bond the functionalized glass patch to the substrate. There are also many other possible solutions for the attachment. Thus, the glass patch is optically and mechanically bond to the pane substrate and more particularly the glass substrate to ensure a good adhesion, transparency and/or clarity.

According to the present invention, the functionalized glass patch may have any size and shape, and may be applied on a big piece of substrate to offer localized coating functions.

Thanks to the present invention, by coating only a small piece of glass, it offers the following benefits:
online coating techniques, like CVD, can be used,
it does not need the big coating facility (like the vacuum chamber) to hold the full piece of glass substrate. Hence it reduces the cost, and increases the coating feasibility,
it saves coating materials without wasting them,.
it adapts to most of the coating techniques, even those working with only small-sized glass, like RAS,
it does not need de-coating process after coating,
it does not need coating masks,
dedicated coating functions are directly available, like AR coatings and tinted coatings.

Coating a glass patch presents the following advantages:
it has easy bonding between the coating materials and the glass patch,
it is resist to most of the coating processes, because glass is tolerant to critical process conditions (like high temperature and chemical corrosion),
glass has a long lifetime.
glass has a strong mechanical and chemical resistance.

Furthermore, the proven autoclaving assembly process is directly applicable for the attachment. Therefore, the functionalized glass patch can be attached to automotive glazing (like WS) during the autoclaving assembly process for the automotive glazing.

Furthermore, the functionalized glass patch can be very thin, e.g. less than 1 mm. Hence, it is not only light-weighted and aesthetic, but also can be bent easily to fit to the shape of the big substrate. By cold bending of the glass patch, it also helps to reduce surface distortions. Even the glass patch is not supposed to be bent, a thin thickness is preferred, to be aesthetic and light weighted.

Thus, the present invention proposes a functionalized glass patch with dedicated coatings to be attached to a substrate (e.g. glass, plastic), so that localized coatings can be realized. In a preferred embodiment, the optical device is an integrated LiDAR sensor attached on an automotive windshield.

The pane with an optically transparent sensor area comprises at least a pane and at least an optically transparent sensor area. In the context of the invention, the expression “optically transparent sensor area” refers to the part of the pane that supplies the sensor with the relevant optical and electromagnetic data or signals. This can be any part of the pane or an inserted pane segment that has high transmission for the relevant optical and electromagnetic signals. The optically transparent sensor area preferably occupies less than 10%, preferably less than 5% of the surface of the pane, more preferably less than 2%, and more preferably less than 1% of the surface of the pane. For example, for automotive glazing, the optically transparent sensor area wherein the optical device and more particularly a Lidar will be placed. The glass patch arranged between the substrate and the optically transparent sensor comprises at least a coating. In the context of the invention, the coating may be affixed both on the side of the glass patch facing the pane and/or also on the side of the glass patch turned away from the pane. The glass patch preferably has a thickness less than 1 mm, and more preferably less than 0.5 mm . . . The averaged transmission of the entire arrangement of sensor area is preferably more than 60%, particularly preferably more than 70%.

The optical sensor device preferably comprises cameras for visible light of wavelengths from 400 nm to 750 nm and infrared light of wavelengths from 750 nm to 1650 nm.

The pane substrate preferably contains glass and/or polymers, preferably flat glass, float glass, quartz glass, borosilicate glass, soda lime glass, polymethyl methacrylate, and/or mixtures thereof. The pane preferably comprises single plane safety glass or a laminated safety glass.

More preferably, the pane substrate is a glass pane.

More preferably, the glass pane according to the invention has an absorption coefficient in the wavelength range of 750 nm to 1650 nm, generally used in optical technologies relating to the invention, very low compared to conventional glasses. In particular, the glass sheet according to an embodiment of the present invention, has an absorption coefficient in the wavelength range from 750 nm to 1650 nm lower than 5 m⁻¹. Preferably, the glass sheet has an absorption coefficient of lower than 3 m⁻¹, or even lower than 2 m⁻¹ and, even more preferably lower than 1 m⁻¹, or even lower than 0.8 m⁻¹.

A low absorption presents an additional advantage that the final IR transmission is less impacted by the optical path in the material. It means that for large field of view (FOV) sensors with high aperture angles the intensity perceived at the various angles (in different areas are the image) will be more uniform, especially when the sensor is optically coupled to the glazing.

Thus, when an autonomous vehicle encounters an unexpected driving environment unsuitable for autonomous operation, such as road construction or an obstruction, vehicle sensors through the glazing according to the invention can capture data about the vehicle and the unexpected driving environment. The captured data can be sent to a remote operator or to the central intelligence unit. The remote operator or unit can operate the vehicle or issue commands to the autonomous vehicle to be executed on various vehicle systems. The captured data sent to the remote operator/unit can be optimized to conserve bandwidth, such as by sending a limited subset of the captured data.

According to an embodiment of the present invention, the glass pane substrate and the glass patch provided between the optical device have an absorption coefficient in the wavelength range from 750 nm to 1650 nm lower than 5 m⁻¹, preferably, the glass sheet has an absorption coefficient of lower than 3 m⁻¹, and the optical device is an infrared-based remote sensing device in the wavelength range from 750 to 1650 nm.

The sensor area preferably has an optical transparency for visible light (VIS) and/or infrared radiation (IR) of >60%, preferably >70%.

The glass patch preferably contains flat glass, float glass, quartz glass, borosilicate glass, soda lime glass, aluminosilicate glass. The glass substrate preferably has an optical transparency for visible light and/or infrared irradiation (IR) of more than 80%, particularly preferably more than 90%.

Coating applied on the surface of the glass patch is preferably chosen amongst an anti-Reflective (AR) coating, a bandpass filter coating, a heated coating, a tinted coating, a selective coating (Infrared—IR coating), an antifog coating . . .

An AR coating is preferably provided on its side in contact/facing the optical device when the optical device particularly when the optical sensor is an IR-based remote sensing device and more particularly when t IR-based remote sensing device is a LIDAR. The AR coating enhances the transmission at interested wavelengths, which reduces operational problems (e.g. reflection problem, heating problem) and improves the sensor performance (e.g. detection range).

The heated coating preferably has a layer thickness of 0.1 μm to 50 μm particularly preferably 1 μm to 10 μm.

The glass patch preferably contains further an optically transparent coating chosen amongst antistatic, water absorbing, hydrophilic, hydrophobic, or lipophobic and hydrophobic coating.

The invention further includes the use of the pane with an optical sensor according to the invention in motor vehicles, ships, airplanes, and helicopters.

The pane with an optical sensor is preferably used as a windshield and/or rear window of a motor vehicle.

In the following, the invention is explained in detail with reference to a drawing. The drawing in no way restricts the invention.

For simplicity, the numbering of the pane substrate or more particularly to a glass pane substrate comprising glass sheets in the following description refers to the numbering nomenclature conventionally used for glazing. Thus, the face of the glazing in contact with the environment outside the vehicle is known as the side 1 and the surface in contact with the internal medium, that is to say the passenger compartment, is called face 2. For a laminated glazing, the glass sheet in contact with the outside environment the vehicle is known as the side 1 and the surface in contact with the internal part, namely the passenger compartment, is called face 4.

For avoidance of doubt, the terms “external” and “internal” refer to the orientation of the pane substrate or more particularly to a glass pane substrate during installation as glazing in a vehicle.

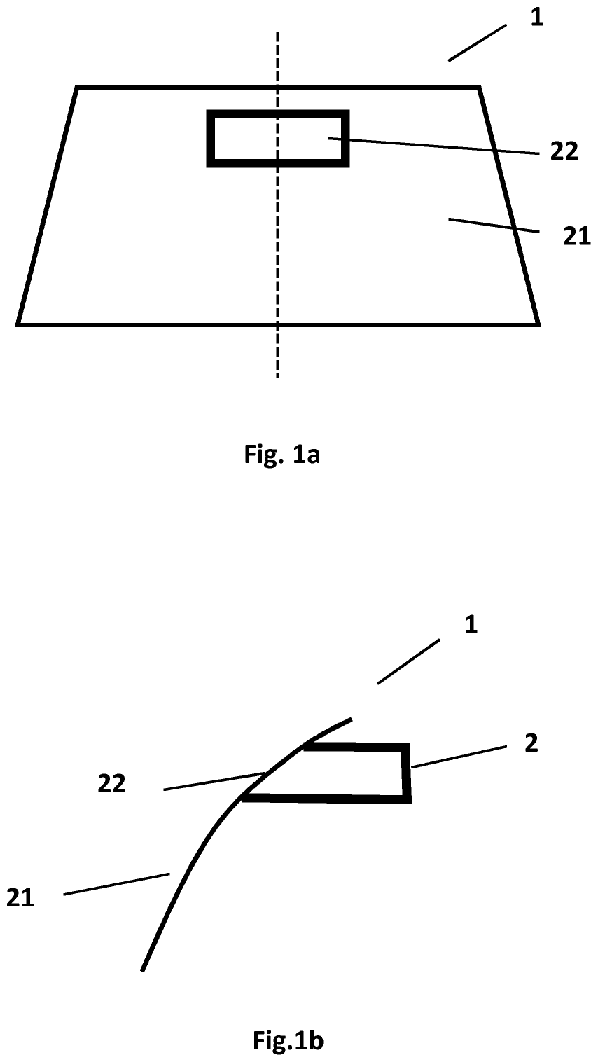

FIG. 1a is a plan view of the pane substrate according to the present invention, with an optically transparent sensor area according to the invention

FIG. 1a is a cross-section of a pane of FIG. 1 with an optically transparent sensor area according to the invention,

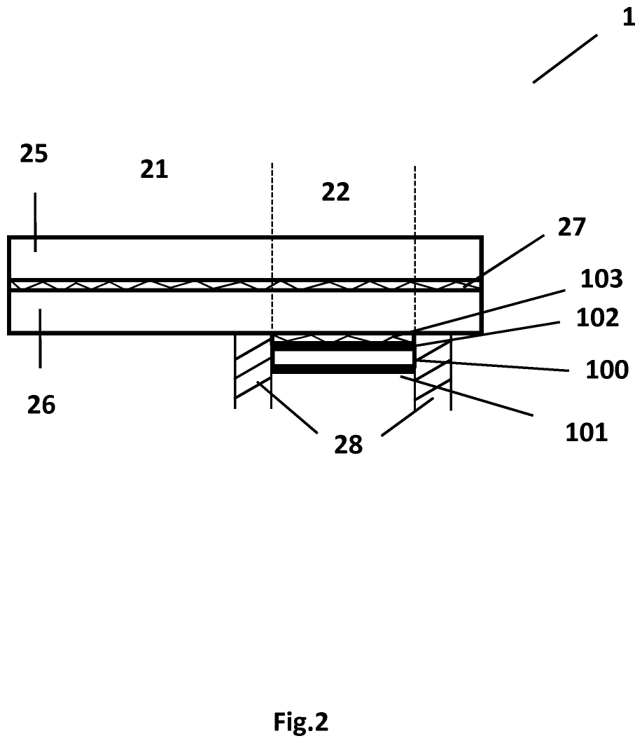

FIG. 2 is a cross-section of a pane according to an embodiment of the present invention.

FIGS. 1a and 1b, according to an embodiment of the invention, represent an automotive glazing. The automotive glazing 1 is a laminated glazing comprising an exterior and an interior glass sheets laminated with at least one thermoplastic interlayer. More particularly, FIGS. 1a and 1b illustrates a LiDAR sensor 2 as optical device, integrated on a windshield 1. According to the present invention, from the front view, the windshield 1 is divided into two zones Zone 21 is the major surface of the windshield and the optically transparent area 22 corresponds to according to the present invention. For the major surface 21, the windshield is coated with a coating blocking the infrared (IR) light to provide thermal comfort for the inside of the car. In the optically transparent area 22 where the LiDAR sensor 2 is integrated, it is needed to transmit the used IR light as much as possible to ensure optimal performances of the LiDAR sensor. Therefore, a localized antireflective (AR) coating for IR light within the optically transparent area 22 will allow the LiDAR sensor to work more efficiently.

According to the present invention, the LiDAR 2 and more generally speaking the optical device will be provided in inner face of the inner glass sheet also called face 4.

According to the present invention, several optical devices including optical sensors may be provided on the substrate, in that case, the number of glass patched should be adapted consequently. It is understood that if optical devices are different, then the coating should be adapted accordingly.

Thus, according to the present area, a functionalized coated glass patch is provided between the windshield 1 and the LiDAR senor 2 as described in FIG. 2.

FIG. 2 shows the layer structure of a windshield 1 integrated with a LiDAR sensor 2 according to one embodiment of the present invention. A classical windshield has a laminated structure, which has two glass sheets, an outer glass sheet 25 and an inner sheet 26 laminated together by an interlayer 27, as the pane substrate.

According to the present invention, a functionalized glass patch 100 is attached within the optically transparent area 22 of the windshield 1, wherein an optical device will be fixed

According to the present invention, the glass patch 100 can be made of soda-lime glass, Alumino-silicate glass, Boro-silicate glass or other glass as needed. The glass patch 100 may be coated either one side or two sides 101, 102 to offer one or multiple coating functions. When an IR-remote device and more particularly a LiDAR is used as optical device, a coating 101 such as an antireflective coating for the used IR light on the surface facing to the optical device is highly recommended to ensure good performance of the LiDAR. The other side of the glass patch 100 and facing the outer face of the inner glass sheet (also called face 4) may be coated with another functionalized coating 102 such as, a tinted coating to be aesthetic or any other coating which has no impact on the performances of the LiDAR and more generally speaking on the optical device. The fixation of the functionalized glass patch 100 to the inner face of the inner glass sheet in the optically transparent area 22 can be made either by autoclave assembly using an interlayer 103 (like PVB, EVA and others), or by optical bonding using special materials 103 (like 3M materials, AGC Infoverre), or by other ways suitable for the fixation of the glass patch to the pane substrate. It is understood that the method of fixation of the functionalized glass patch 100 described above may be used for a monolithic glass pane substrate or plastic pane substrate or mix thereof when it is applicable. The thickness of the glass patch may be preferably thin ie less than 1 mm. A thin glass patch may be bent more easily to fit the shape of the windshield 1 or the pane substrate. Besides, thin glass patch is light-weighted and aesthetic.

The edges of the functionalized glass patch can be easily hidden and sealed by a bracket 28 holding the LiDAR system.

It should be mentioned that the application of the functionalized glass patch above is just an illustrative example. And this glass patch can have different coating functions, and can be attached to any substrate with many materials and different shapes. It is understood also that the pane substrate may be a trim element more particularly a glass trim element, a side lite, . . .

1. A pane substrate with an optically transparent area comprising an optical device on a surface of the pane integrated in the optically transparent area,
wherein at least one coated glass patch is provided locally between the pane and the optical device.

2. The pane according to claim 1, wherein the optical device is an optical sensor device.

3. The pane according to claim 1, wherein the pane comprises glass and/or polymers.

4. The pane according to claim 1, wherein the glass patch comprises glass.

5. The pane according to claim 1, wherein the optically transparent area has an optical transparency for visible light and/or infrared radiation of >60%.

6. The pane according to claim 1, wherein the glass patch is provided with at least one coating.

7. The pane according to claim 1, wherein the glass patch is bonded optically and mechanically to the substrate.

8. The pane according to claim 1, wherein the glass patch has a thickness of <1 mm.

9. The pane according to claim 1, wherein the coating is provided on the side of the glass patch facing the pane and/or on the side of the glass patch turned away from the pane.

10. The pane according to claim 1, wherein the pane is an automotive glazing and more particularly a windshield.

11. The pane according to claim 2, wherein the optical sensor is an infrared-based remote sensing device in the wavelength range from 750 nm to 1650 nm (LIDAR sensor).

12. The pane according to claim 1, wherein the pane substrate and the glass patch have an absorption coefficient lower than 5 m⁻¹ in the wavelength range from 750 nm to 1650 nm

13. The pane according to claim 4, wherein the glass patch is provided on an inner face and the size of glass patch fits with the size of the field of view of the optical device.

14. The pane according to claim 2, wherein the optically transparent sensor area occupies less than 10% of the surface of the pane substrate.

15. The pane according to claim 2, wherein the optical sensor device comprises sensors for visible light of wavelengths from 400 nm to 750 nm and infrared light of wavelengths from 750 nm to 1650 nm.

16. The pane according to claim 3, wherein the glass and/or polymers are selected from the group consisting of flat glass, float glass, quartz glass, borosilicate glass, soda lime glass, aluminosilicate glass, or polymethyl methacrylate, and/or mixtures thereof.

17. The pane according to claim 4, wherein the glass patch is selected from the group consisting of flat glass, float glass, quartz glass, borosilicate glass, soda lime glass, aluminosilicate glass or mixtures thereof.

18. The pane according to claim 5, wherein the optically transparent area has an optical transparency for visible light and/or infrared radiation of >70%.

19. The pane according to claim 6, wherein the glass patch is provided with at least one coating selected from the group consisting of an anti-reflective coating, a tinted coating, a heated coating, a bandpass coating, or an antifog coating.

20. The pane according to claim 14, wherein the optically transparent sensor area occupies less than 5% of the surface of the pane substrate.
